(19) United States
(12) Patent Application Publication
(10) Pub. No.: US 2002/0131001 A1
(43) Pub. Date: Sep. 19, 2002

(54) Electro-optical device having an ITO layer, a SiN layer and an intermediate silicon oxide layer

(76) Inventors: Antonius Henricus Maria Raaijmakers, Eindhoven (NL); Theodorus Wilhelmus Lathouwers, Eindhoven (NL)

Correspondence Address: Corporate Patent Counsel, U.S. Philips Corporation, 580 White Plains Road, Tarrytown, NY, 10591, US

(21) Appl. No.: 09/745,914

(22) Filed: Dec. 22, 2000

(30) Foreign Application Priority Data
Dec. 24, 1999 (EP) 99204531.0

(51) Int. Cl. G02F 1/1343

(52) U.S. Cl. 349/139

(57) ABSTRACT

An electro-optical device such as a fingerprint sensor or an X-ray image sensor has an ITO (indium tin oxide) layer (67) and a SiN layer (64A) near the ITO layer. An intermediate layer (64B) of silicon oxide is provided between the ITO layer and the SiN layer. This intermediate layer prevents reduction of the ITO layer during manufacture.

The invention relates to an electro-optical device having an ITO (indium tin oxide) layer and a SiN layer near the ITO layer.

Electro-optical devices are, for instance, liquid crystal display devices or image sensors.

A device of the type described in the opening paragraph is known from N. C. Bird, C. J. Curling, C. van Berkel ‘Large-image sensing using amorphous silicon nip diodes’ in Sensors and Actuators A (1995) pages 444-448 wherein a description is given of large-area image sensors. The sensors comprise a two dimensional array of pixels, each pixel comprising a photosensitive element. The photosensitive element comprises an amorphous silicon (a-Si) p-i-n or n-i-p photodiode. Light incident on each photodiode generates a photocurrent. The amount of photocharge is subsequently transferred to drive electronics by a matrix of a-Si switching devices. A transparent ITO comprising electrode is provided on top of the diodes (photodiodes as well as switching diodes).

ITO electrodes are used in electro-optical devices because they are transparent, yet have a reasonable conductance.

A SiN layer covers the ITO layer at least partially.

Large-area image sensors include, for instance X-ray imagers and contact document readers. Similarly as liquid crystal devices, they are usually manufactured by using thin-film technology on substrates.

For proper functioning of the devices, it is important that the optical properties (in particular, the transparency) and the electrical properties (in particular, the conductance and capacity) of the ITO layer are well known and controlled. Variations of these properties, dependent on whether the ITO layer is used as an electrode for photodiodes or switching diodes (or more complicated structures such as phototransistors), leads to inaccuracy in the image sensors and in the performance of the device, in particular a reduction of contrast. The same applies to LCD devices.

It is an object of the invention to provide a device of the type described in the opening paragraph in which the properties of the ITO layer are better controlled or controllable.

To this end, a device in accordance with the invention is characterized in that an intermediate layer of silicon oxide is provided between the ITO layer and the SiN layer.

The inventors have found that the ITO layer is often at least partially reduced during manufacture of the device. The reduction of the layer leads to islands of metallic indium being present (or at least parts with a strongly increased metallic indium and tin content). This leads to two changes in the property of the ITO layer, namely, the transparency is reduced and the etching properties are changed. Both of these changes reduce the quality of the device. A reduction of transparency reduces the sensitivity of the device (for sensors) or the light output of the device (LCD).

The inventors have realised that these effects occur in particular during two process steps:

When the SiN layer is provided by means of chemical vapor deposition, this is done in a reducing atmosphere. During deposition, the ITO layer, which has already been deposited, is partially (or completely) reduced, forming metallic indium and tin. Moreover, when the SiN layer has been deposited, it is usually thereafter patterned by means of etching (for instance, with HF). ITO, which is partly reduced, will be severely attacked when it is in contact with the etching fluid for nitride etching, causing major problems for the device functionality.

However, ITO, which has been protected during deposition of nitride, will be fully resistant to the etching fluid for nitride etching. The etching rates for SiN and SiO are almost comparable.

The intermediate SiO layer acts as a barrier preventing (or at least strongly decreasing) the reduction of the ITO layer during manufacture and improving, inter alia, the etching properties as well as the optical and electrical properties of the ITO layer and thereby the quality of the device.

These and other aspects of the invention are apparent from and will be elucidated with reference to the embodiments described hereinafter.

In the drawings:

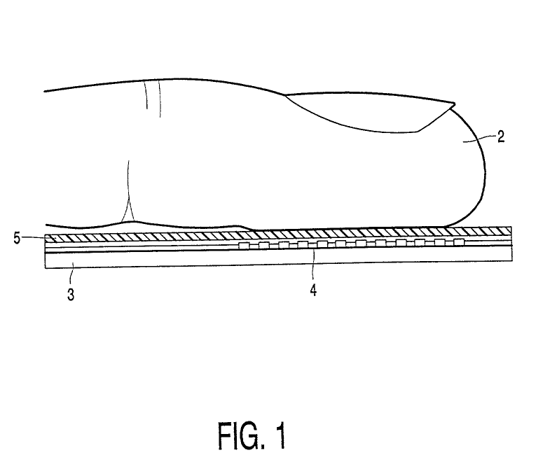

FIG. 1 is a schematic, cross-sectional view of an optical contact document reader, in this example a fingerprint sensing device.

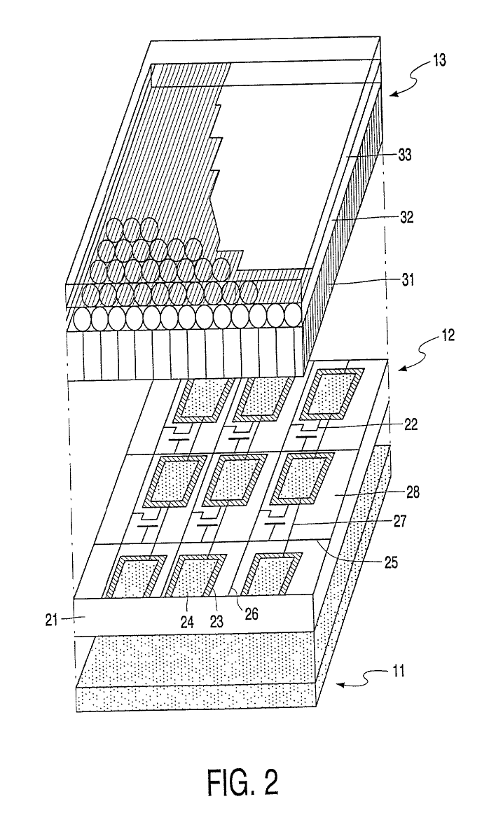

FIG. 2 shows a detail of a fingerprint sensing device.

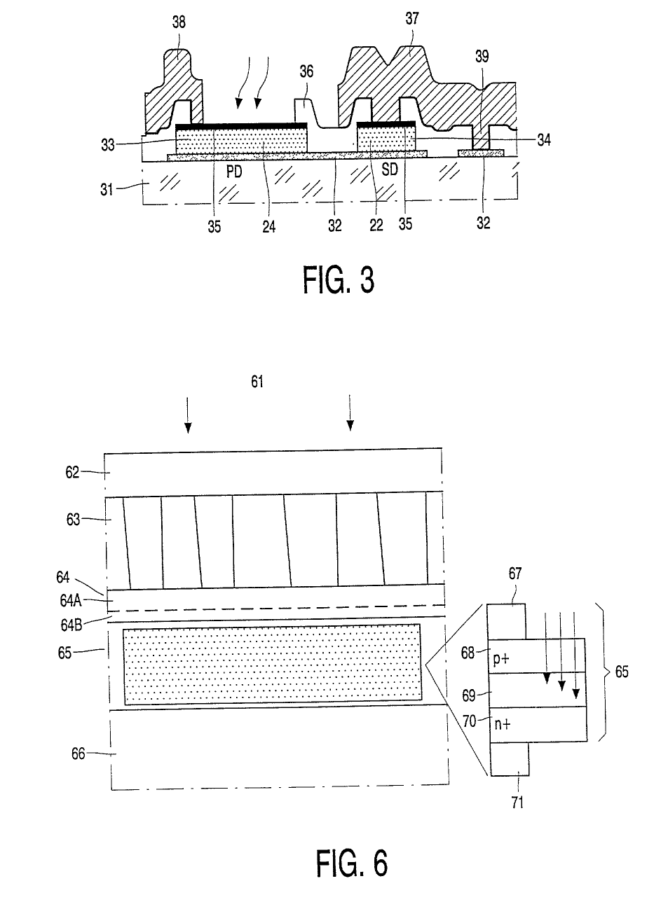

FIG. 3 shows schematically an image sensor pixel of a 2D image sensor array employing a-Si nip diodes as the matrix switch.

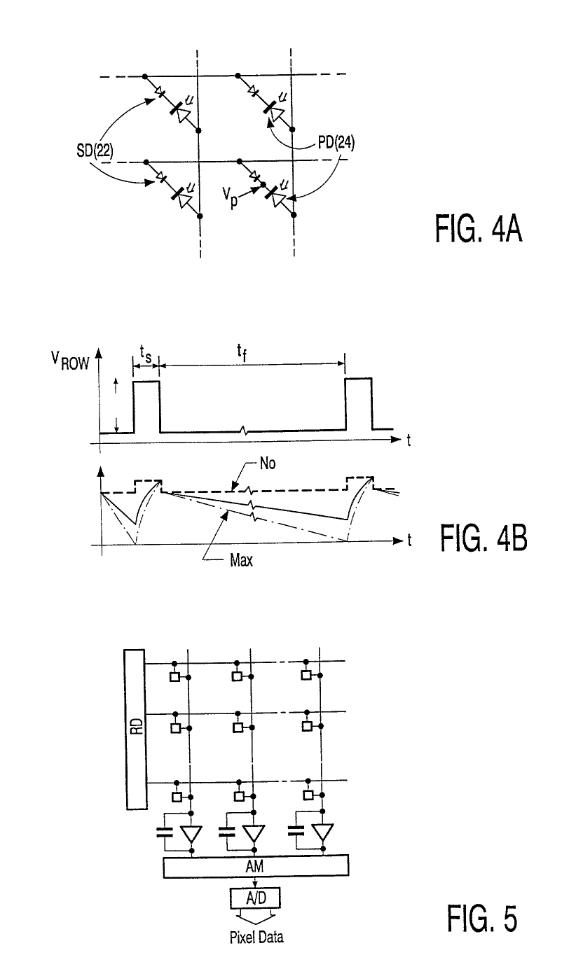

FIG. 4A illustrates the pixel circuit diagram.

FIG. 4B illustrates the resulting waveforms.

FIG. 5 illustrates a drive system block diagram for a 2D image sensor array.

FIG. 6 is a schematic, cross-sectional view of an image sensor plate for an X-ray detector in accordance with the invention.

The Figures are not drawn to scale and corresponding numerals in the Figures refer to the same or similar parts of a device.

FIG. 1 shows schematically a fingerprint sensing device.

Finger 2 touches the fingerprint sensing device. The device comprises a light source 3, a 2D array of photosensitive elements 4 and an optical element 5.

The fingerprint sensing device is shown, by way of example, in more detail in FIG. 2.

The device comprises a transparent substrate 21, a planar light source 3, and an optical element 5 defining optical paths. 2D array 4 having openings 28 through which light can be passed is formed on transparent substrate 21. A backlight module for a liquid light crystal display or an EL planar light source can be utilised for light source 3. 2D array 4 comprises a plurality of picture elements each comprising a photosensitive element 24 and switch elements 22, interconnected by switching lines 25, signal reading lines 26 and bias applying lines 27. Optical element 5 comprises a diffraction grating 32 combined with fiber members 31 and a transparent protective film 33. The components of the optical elements have such a shape that light may be focused upon a finger-contacting area of the transparent protective film located on center parts of the openings 28. Light emitted by the light source 3 passes through the openings 28 of 2D array 4 and fiber member 31, and then the light is bent by the diffraction grating so that it reaches the finger contacting area of transparent protective film 33. When no finger is in contact with the surface of protective film 33, the light is totally reflected. Consequently, almost all of the light follows symmetrical light paths and reaches photosensitive elements 24 in the same picture elements. On the other hand, when a finger or actually the ridge lines of the finger is (are) in contact with the surface of transparent film 33, the requirement for total light reflection is not met, and only a little light comes to photosensitive elements 24. Consequently, ridge lines of a fingerprint can be detected because there is no longer total reflection at said ridge lines. In particular, a fingerprint image is obtained. It is to be noted that the invention is not limited to the type of fingerprint sensor device shown in FIG. 2 since it relates to the layer overlaying the elements 24. Other elements of the fingerprint sensor are shown for the purpose of illustration and may differ for different types of fingerprint sensors.

FIG. 3 is a schematic cross-section of an image sensor pixel comprising a photosensitive element 24 and a switching element 22. The pixel comprises electrodes 32, in this example comprising Cr (Chromium), on a base plate 31. The photosensitive element 24 and the switching element 22 comprise a layer of amorphous silicon 33, and 34, respectively, on top of which a transparent electrode comprising ITO (indium tin oxide) is provided. The array is also provided with a SiN layer 36 and an aluminium lead 37. The switching diode (SD) is completely shielded from the light by the aluminium and chromium layers, while the top contact of the photosensitive diode (PD) is made in such a way that light can enter through the transparent ITO electrode. The position of the column contacts 38 and the row contacts 39 is also indicated.

The arrangement of the pixel circuit in a 2D array is indicated in FIG. 4A, and the corresponding row addressing waveforms are indicated in FIG. 4B. Each row of pixels in the array is addressed periodically with a select voltage pulse of amplitude Vₛ and duration tₛ. Considering now the situation for a pixel immediately after the end of a select pulse, it is clear that current flowing through the forward biased switching diode 22 has charged the capacitance of the photodiode 24. Following the falling edge of the select pulse, both diodes are reverse-biased. During the interval t_{f} between consecutive select pulses, the photodiode capacitance is discharged by the photocurrent in the photodiode, and this amount of charge is detected during the following select pulse when the photodiode capacitance is charged back to its starting value. The waveforms in FIG. 4B show how the pixel voltage Vₚ varies according to the intensity of the light incident on the photodiode.

A block diagram of the drive system utilized to acquire images is shown in FIG. 5. The row drive (RD) sequentially addresses each row of pixels in the array by applying the two-level waveform described above. Charge-sensitive amplifiers connected to each column detect the amount of charge required to recharge the pixel photodiodes during the select period, and these amplifiers also keep the columns at a fixed potential (typically 0 V). The drive system employs LCD row driver chips. Each amplifier chip is connected to an A/D converter. Data are sent to a PC for subsequent processing of the image data. FIGS. 4 and 5 illustrate the functioning of a type of fingerprint sensor, but should not be considered to be limitative for the invention which relates to the ITO electrode and the SiN layer, which may be present in other types of fingerprint sensors or image sensors which may use different electronic circuits.

The ITO electrode (within the concept of the invention, the ITO could be doped with, for instance, antimony which is also called ATO (Antimony doped indium Tin Oxide)) is in contact with the SiN layer. The quality of the device and, in particular, the consistency of the data relies on the properties of the ITO electrode. Optical properties (transparency) as well as electrical properties (resistance) play an important role. The invention for its object to improve these properties and, in particular, the reliability of the ITO layer.

To this end an intermediate layer of silicon oxide (SiO,) is provided between the ITO layer and the SiN layer.

For proper functioning of the devices, it is important that the optical properties (in particular, the transparency) and the electrical properties (in particular, the conductance and capacity) of the ITO layer are well known and controlled. Variations of these properties, dependent on whether the ITO layer is used as an electrode for photodiodes or switching diodes (or more complicated structures such as phototransistors), leads to inaccuracy in the image sensors and in the performance of the device, in particular a reduction of contrast. The same applies to LCD devices.

The inventors have found that the ITO layer is often at least partially reduced during manufacture of the device. The reduction of the layer leads to islands of metallic indium being present (or at least parts with a strongly increased metallic indium and tin content). This leads to two changes in the property of the ITO layer, namely, the transparency is reduced and the conductance is increased. Both of these changes reduce the quality of the device. A reduction of transparency reduces the sensitivity of the device (for sensors) or the light output of the device (LCD). An increase of the conductance leads to changes in switching and control voltages, reducing the reliability of the device.

The inventors have also realised that these effects occur in particular during two process steps:

When the SiN layer is provided by means of chemical vapor deposition, this is done in a reducing atmosphere. During deposition, the ITO layer, which has already been deposited, is partially (or completely) reduced, forming metallic indium and tin. Moreover, when the SiN layer has been deposited, it is usually thereafter patterned by means of etching (for instance, with HF). ITO, which is partly reduced, will be severely attacked when it is in contact with the etching fluid for nitride etching, causing major problems for the device functionality.

However, ITO, which has been protected during deposition of nitride will be fully resistant to the etching fluid for nitride etching. The etching rates for SiN and SiO are almost comparable.

The intermediate SiO layer acts as a barrier preventing (or at least strongly decreasing) the reduction of the ITO layer during manufacture and improving the optical and electrical properties of the ITO layer and thereby the quality of the device, without introducing problems during subsequent etching.

FIG. 6 shows, in a cross-sectional view, an image sensor plate for an X-ray detector. The image sensor plate comprises a light reflector 62, for instance, comprising TiO₂ on which X-rays 61 are in incident operation. It further comprises a scintillator layer 63, for instance, comprising CSI:Ti, an a-Si large-area thin-film electronics layer 65 which comprises ITO layers 67, a stack of layers p+ a-Si (68), intrinsic a-Si (69) and n+ a-Si (70) and metal layer (71) on a substrate 66. In between the scintillator layer 63 and the a-Si large-area thin-film electronics layer 65, a passivation layer 64 is provided which comprises a SiN layer 64A separated from the ITO layer 67 by a SiO layer 64B.

It will be clear that many variations are possible within the scope of the invention.

1. An electro-optical device having an ITO (indium tin oxide) layer and a SiN layer near the ITO layer, characterized in that an intermediate layer of silicon oxide is provided between the ITO layer and the SiN layer.

2. An electro-optical device as claimed in claim 1, characterized in that the electro-optical device is a fingerprint sensor.

3. An electro-optical device as claimed in claim 1, characterized in that the electro-optical device is an X-ray image sensor.
